(19) United States
(12) Patent Application Publication
(10) Pub. No.: US 2005/0208225 A1
(43) Pub. Date: Sep. 22, 2005

(54) Coating apparatus and coating method

(75) Inventor: Kazuhiko Sakata, Tokyo (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/074,202

(22) Filed: Mar. 7, 2005

(30) Foreign Application Priority Data
Mar. 19, 2004 (JP) JP2004-079902
Mar. 23, 2004 (JP) JP2004-084675

(51) Int. Cl. B05D 5/06; B05D 5/12

(52) U.S. Cl. 427/421.1; 118/300; 118/301

(57) ABSTRACT

A coating apparatus which produces ink jet recording media by conveying a substrate and by spraying droplets of a coating solution across the substrate's coating width perpendicular to the conveyance direction of the substrate, to form a layer of the coating solution on the substrate by means of a spray coating device, and which has a first casing containing the spray coating device and a pressure reducing means to maintain a reduced pressure condition in the first casing and conducts coating while maintaining reduced pressure value Ps of −50 to −3,000 Pa in the first casing.

### BACKGROUND OF THE INVENTION

The present invention relates to a coating apparatus to produce ink jet recording media by spraying a coating solution to form liquid droplets to coat a substrate, and to a coating method in which a coating apparatus is employed.

Various methods have been known which apply a coating solution onto a substrate. For example, as Non-Patent Document 1 describes, various methods in which a coating solution is accurately applied onto a long belt-shaped substrate are proposed, for example, a known dip coating method, a blade coating method, an air knife coating method, a wire bar coating method, a gravure coating method, a reverse coating method, a reverse roll coating method, an extrusion coating method, a slide bead coating method, as well as a curtain coating method. Further, in these coating methods, in order to achieve a uniform dried layer thickness across the width of the substrate with high accuracy, coating is carried out while paying particular attention to accuracy and uniformity of coating thickness during the entire coating process (prior to as well as after coating).

Of these coating methods, particularly the coating apparatus, which includes a flow rate regulating type dice, is capable of achieving high speed, thin layers and multilayer simultaneous coating. Due to these features, it is widely employed as a coating apparatus for light-sensitive photographic materials, ink jet recording materials, and magnetic recording materials.

Employed as one preferable example of the aforesaid coating apparatus is a slide bead coating apparatus, proposed by Russell et al in Patent Document 1. Alternatively, an extrusion coating apparatus is also widely employed. Further, a curtain coating apparatus, which is a flow rate regulating type apparatus including dice, is also widely employed.

For example, in the case of the aforesaid slide bead coating apparatus, a maintained coating solution, called a bead, is formed between the leading end of the coating apparatus and the conveyed substrate, and coating is carried out via the bead. Further, in the case of the curtain coating apparatus, a curtain-shaped coating solution layer is subjected to free-fall and coating is carried out while positioning a substrate under the falling solution. These apparatuses are very useful to achieve a uniform dried layer thickness with high accuracy.

On the other hand, during coating, which employs such coating apparatuses including dice, the coating apparatus and the substrate are in contact continuous employing the coating solution such as a bead and curtain film, due to its principle. In order to form a uniformly thick coating layer on the substrate, the flow rate of the coating solution from the coating apparatus should always be constant and be continuously fed. Namely, in order to continuously form the coating layer, as well as to maintain a constant coating layer thickness with high accuracy, a coating solution amount more than the specified is required. Accordingly, in these systems, when the amount of coating solution discharged from the coating apparatus is excessively reduced, it becomes difficult to achieve the purpose for obtaining uniform layer thickness.

Due to that, when the desired layer is excessively thin (for example, about 1 to about 50 μm), prior to drying the coating layer, it becomes necessary to increase the layer thickness by means of increasing the total amount of the coating solution by increasing the amount of solvents in the aforesaid coating solution. In this case, specifically, when the viscosity of the coating solution is low, the coating layer flows on the substrate. As a result, it is difficult to form a stably uniform coating layer.

Further, when the solvent amount increases, load (drying load), to dry the coating layer through solvent evaporation, increases. Such an increase is not preferable from the viewpoint of production efficiency. Beyond that, when another composition layer has been applied under the aforesaid coating layer, the subsequent excessive solvent amount causes excessively long drying time, also occasionally results in adverse effects due to excessive penetration and diffusion of the previous coating solution layer.

In the production process of an ink jet recording media in which a thin layer of uniform thickness with high precision is formed on a substrate at high speed, in the case of providing a further thin layer on an already coated and formed composition layer, it is necessary to provide a coating apparatus and a coating method having a total high product efficiency without adverse effects to the aforesaid composition layer. In the case where a thin overcoating layer is provided on an ink absorptive layer as a composition layer, a producing method and a producing apparatus of ink jet recording media which are excellent in characteristics, coating layer uniformity and coating stability are provided as shown in Patent Documents 2 and 3. A coating apparatus employing a spray is disclosed in Patent Documents 4 and 5, and it is applicable to highly viscous coating solution like adhesives, which however is not adequate to be used as an apparatus for a thin layer of an overcoating layer which the present invention targets. Regarding an apparatus described in said Patent Documents 2 and 3, scattering of liquid droplets and resulting spot type defects on the coated surface as well as stains on the apparatus tend to occur. In Patent Document 3, a study was carried out for a preventive method of liquid droplet scattering to describe structures of droplet scattering prevention equipment, however it was not sufficiently effective and not completed because the condition ranges of the equipment are not described.
[Patent Document 1] U.S. Pat. No. 2,761,791
[Patent Document 2] Tokugan No. 2002-49715
[Patent Document 3] Tokugan No. 2002-253172
[Patent Document 4] Tokkai No. Hei05-309310
[Patent Document 5] Tokkai No. Hei06-170308
[Non-Patent Document 1] “Modern Coating and Drying Technology” by Edward Cohen, Edgar Gutoff

### SUMMARY OF THE INVENTION

The objective of the present invention is to solve these problems caused by the conventional technique and to provide a coating apparatus and a coating method which prevents scattering of surplus droplets, spot type non-uniformity created by scattered droplets and staining of the apparatus (including coating defects from drops of dried layer of staining materials).

The objective can be achieved by the following apparatus and method.

(A) A coating apparatus for producing ink jet recording media composed of a conveying device to convey a substrate in a conveyance direction, a spray coating device to spray liquid droplets of a coating solution across a coating width of the substrate perpendicular to the conveyance direction of the substrate to form a layer of the coating solution on the substrate, a first casing in which the spray coating device is equipped and a pressure reducing device to maintain a reduced pressure condition in the first casing, wherein the coating apparatus conducts coating while maintaining reduced pressure value Ps of −50 to −3,000 Pa in the first casing.

(B) A coating method, wherein ink jet recording media are produced by employing the coating apparatus (A) so as to spray liquid droplets of a coating solution by a spray coating device to form a layer of the coating solution on a substrate.

By means of a coating apparatus and a coating method of the present invention, the relationship between the reduced pressure of the first casing containing the spray coating device for coating on the substrate, and the reduced pressure of the second casing located opposite of the substrate relative to the first casing was studied to establish optimal coating condition so that conveyance of a substrate and a coating on a substrate does not cause spot type defects and provide a uniform satisfactory coating situation.

Further, the appropriate conditions of the gap size between the masking plates and substrate was established for stable and satisfactory coating.

Further, appropriateness of the edge shape and the material for the masking plate became known and this invention contributed much to stable and satisfactory coating and prevention of staining to the apparatus.

By means of the coating apparatus and the coating method of this invention which uses a spray coating device discharging auxiliary gas toward the substrate to be coated by employing guide plates and current plates, it became possible to provide a coating apparatus and a coating method which can produce ink jet recording media such as recording sheets which has stable quality without spot type defects or staining to the apparatus caused by scattering of large liquid droplets.

### BRIEF DESCRIPTION OF THE DRAWINGS

FIG. 1 is a perspective view of the spray coating device of a coating apparatus of this invention, to be used for production of ink jet recording paper sheets.

FIG. 2 is a schematic cross-sectional view of the coating apparatus of this invention equipped with the spray coating device.

FIG. 3 is an enlarged cross-sectional view explaining the spray coating device and the shape and the spreading condition of droplets onto the substrate.

FIG. 4 is a bottom view of the spray coating device viewed from the coating solution discharging side.

FIG. 5 is an exploded perspective view of the spray coating device.

FIG. 6 is schematic diagram showing an example of production line of coating apparatus equipped with spray coating devices and the coating device for the lower coating layer located upstream of the spray coating device.

FIG. 7 is a cross-sectional view of the coating apparatus of this invention including the spray coating device for production of ink jet recording sheets and the substrate conveying apparatus.

FIG. 8 is a frontal view of the conveying means.

FIG. 9(a) is a schematic plan view showing respective width dimensions of portions of the spray coating device, the substrate and the masking plate and FIG. 9(b) shows the location of said dimensions as cross section A-A in FIG. 1.

FIG. 10(a) is a cross-sectional view showing conditions of spray coating device equipped with auxiliary gas flow guide plates and current plates and FIG. 10(b) is a cross sectional view of A-A in FIG. 1.

### DETAILED DESCRIPTION OF PREFERRED EMBODIMENT

Preferred embodiments to achieve the aforementioned objective of this invention will be explained.

(1) The coating apparatus (A) further composed of masking plates so as to mask outer edges of the substrate, located in a vicinity of a coating solution discharge section of the spray coating device, wherein size of each gap between the masking plates and the substrate is 1 to 15 mm at both outer edges of the substrate.

(2) The coating apparatus (A) further composed of a second casing in which the conveying device is equipped opposite the substrate relative to the first casing and a pressure reducing device to maintain a reduced pressure condition in the second casing, wherein the reduced pressure value in the second casing is −50 to −3,000 Pa.

(3) The coating apparatus (A), wherein the second casing is separated into a plurality of decompression chambers and the pressure reducing device can individually set the reduced pressure value of each decompression chamber, and when the reduced pressure value in the decompression chamber at an entrance of the substrate on an upstream side in the conveyance direction of the substrate is represented by P1, the reduced pressure value in a middle decompression chamber facing the spray coating device is represented by P2, and the reduced pressure value in the decompression chamber at an exit of the substrate on a downstream side is represented by P3, the pressure is reduced so that relationships of P1<Ps<P2 and P3<Ps<P2 are maintained.

(4) The coating apparatus (A), wherein when an auxiliary gas flow is discharged toward a coating section along at least one of outermost surfaces of the spray coating device which has the outermost surfaces on a upstream side and a downstream-side in the conveyance direction of the substrate, and when the discharge pressure on the upstream side in the conveyance direction of the substrate is represented by Ph1 and the discharge pressure on the downstream side in the conveyance direction of the substrate is represented by Ph2 , the condition of the discharge pressure is maintained so as to satisfy the relationships of 100 Pa<Ph1<5,000 Pa and 100 Pa<Ph2<50,000 Pa.

(5) The coating apparatus (A) composed of a guide plate located on an outer portion of each outermost surface of the spray coating device where the auxiliary gas flows, to make the gas flow along the outermost surface of the spray coating device toward the coating section without diffusion of the gas.

(6) The coating apparatus (A) further composed of current plates so as to make the auxiliary gas flowing along the outermost surfaces of the spray coating device toward the coating section flow uniformly across a whole width of the auxiliary gas flow.

(7) The coating apparatus (A), wherein size of a gap between the first casing and the substrate at the entrance and the exit of the substrate is 1 through 10 mm.

(8) The coating apparatus (A) further composed of auxiliary aspiration nozzles arranged in a vicinity of the masking plates to aspirate surplus sprayed liquid droplets.

(9) The coating apparatus (A), wherein the masking plates are structured of a water repellant material.

(10) The coating apparatus (A), wherein each of the masking plates has a decline from the center of the substrate toward the outer edges of the substrate.

(11) The coating apparatus (A) composed of at least one coating solution nozzle discharging the coating solution across the whole coating width and a plurality of gas nozzles discharging a gas, close to an exit of the coating solution nozzle, so as to form liquid droplets by interaction of the gas flow with the coating solution discharged from the coating solution nozzle.

Embodiments of this invention will be explained referring to diagrams.

[Spray Coating Device]

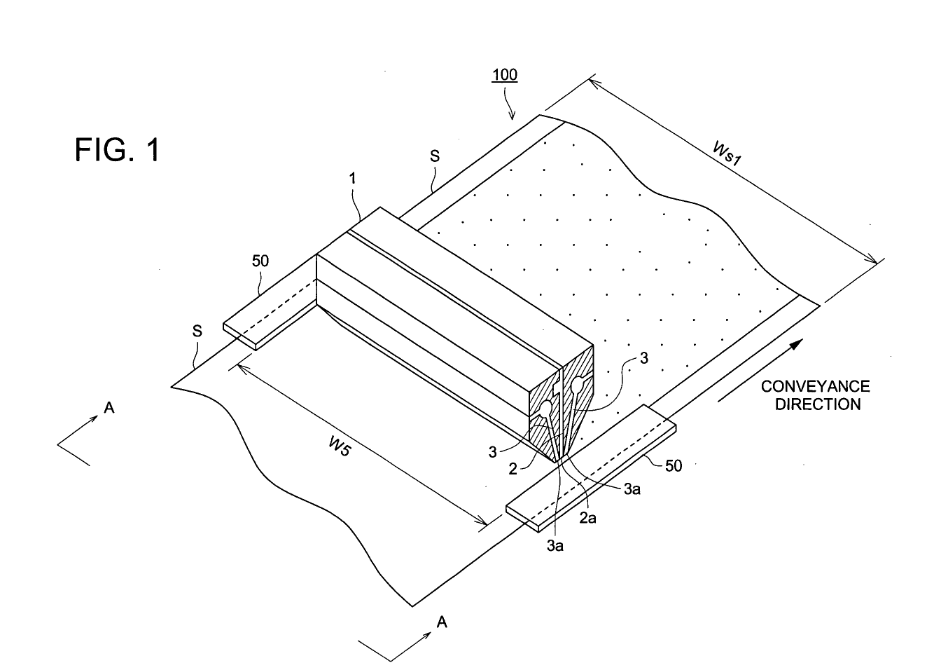

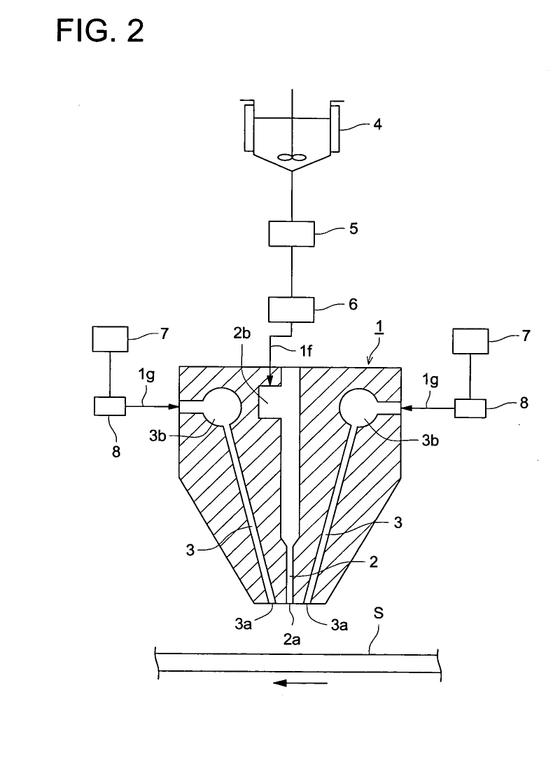

FIGS. 1 and 2 are perspective views of spray coating device 1 integral in a manufacturing apparatus for ink jet recording media and a schematic sectional view of spray coating device 1.

In FIG. 1, reference numeral 1 is the spray coating device, S is a long belt-shaped substrate. Substrate S is conveyed in the direction indicated by an arrow in FIG. 1 at a constant rate, employing a conveyance means (not shown). Coating solution nozzle 2 and gas nozzle 3 of spray coating device 1 span the full width of substrate S which is perpendicular to the conveyance direction and are arranged so as to face the surface to be coated of substrate S. In FIG. 2, the coating solution which is discharged from coating solution discharge section 2a of coating solution nozzle 2, is sprayed in the form of liquid droplets by the pressurized gas discharged from gas discharge section 3a of gas nozzle 3, and coating is carried out so that the droplets are deposited on conveyed substrate S.

Spray coating device 1 includes a pair of gas nozzles 3, having gas pocket 3b, and coating solution nozzle 2, having coating solution pocket 2b. A coating solution is composed of, for example, a functional compound containing solution, having a viscosity (preferably from 0.1 to 250 mPa·s), capable of forming liquid droplets without forming threads. This coating solution is fed into preparation tank 4, and is subsequently supplied to coating solution pocket 2b via pump 5 and flow meter 6, and is then led to coating solution nozzle 2. Further, pressurized air which is fed to pocket 3b via control valve 8 from pressurized air source 7 is supplied to gas nozzles 3.

During coating, the coating solution is supplied from preparation tank 4 so that the specified coating amount is discharged from coating solution nozzle 2. Simultaneously, pressurized air is ejected from a pair of gas nozzles 3, whereby the coating solution is shaped into liquid droplets which are sprayed onto substrate S to be deposited. By supplying the coating solution onto the surface of substrate S in the form of minute liquid droplets, it is possible to form, at high seed, a thin layer having markedly high uniformity, while minimizing drying load.

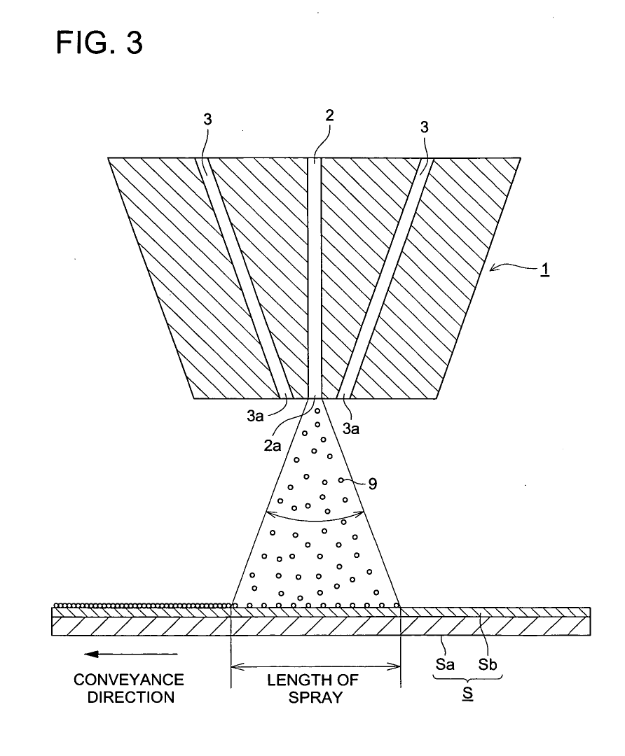

FIG. 3 is an enlarged cross-section of the nozzle end of spray coating device 1, showing as well the pattern of liquid droplets formed on substrate S and the ejected state of liquid droplets.

In FIG. 3, the coating solution, which is discharged from coating solution nozzle 2, is finely divided to form liquid particles, employing compressed air supplied from gas nozzles 3 which are structured adjacent to both sides of coating solution nozzle 2, whereby substantially spherical liquid droplets 9 are formed, which subsequently are deposited uniformly on the surface of substrate S. FIG. 3 shows a model in which substrate S is composed of support Sa having thereon ink absorptive layer Sb, as a composition layer. It is preferable that the spray pattern area of liquid droplets of the coating solution, which is deposited on substrate S, remains uniform. It is also particularly preferable that the length in the conveyance direction (described as length of spray in FIG. 3) remains uniform across the coating width. Further, it is preferable that spreading angle θ of the group of liquid droplets which are sprayed toward the substrate from the opening of coating solution nozzle 2 is uniform across the coating width.

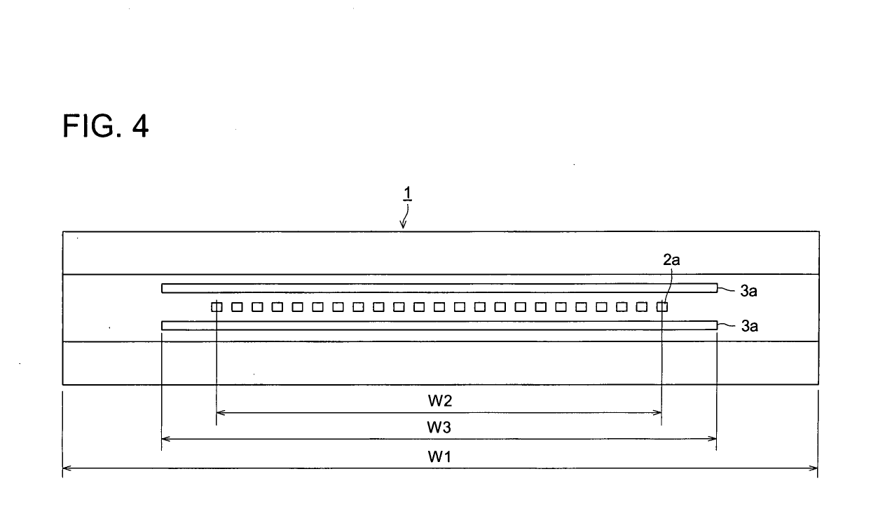

FIG. 4 is a bottom view of the spray coating device 1 in FIG. 3 viewed from the coating solution discharge section 2a and shows plural end openings of coating solution discharge section 2a aligned across the coating width, and gas discharge section 3a.

Regarding coating solution discharge section 2a shown in FIG. 4, twenty-three coating solution discharge sections 2a, having a rectangular opening, are aligned across the coating width. The shape of the discharge section for coating solution is not limited to being rectangular and may also be circular. The discharge section may also be a slit extending across the coating width. As to the size of the end opening, 50 to 300 μm is functional and it is preferable that the pitch (interval) is 100 to 3,000 μm. Further, gas discharge sections 3a which extend across the coating width are structured adjacent on both sides of coating solution discharge sections 2a. The gas discharge section is not limited to a slit and may be a plurality of circular or rectangular end openings similar to the coating solution discharge sections. When the shape of the gas discharge is circular or rectangular, it is preferable that the size is 50 to 300 μm and the pitch is 100 to 3,000 μm. Coating solution discharge sections 2a are arranged at equal intervals. Similarly gas discharge sections 3a are also arranged at equal intervals when they are circular or rectangular.

Herein, two gas discharge sections 3a paired with one coating solution discharge section 2a are considered to be aligned in the direction perpendicular to the coating width. However, coating solution discharge sections 2a and gas discharge sections 3a may alternatively be structured in a zigzag pattern when the openings of gas discharge section 3a are circular or rectangular.

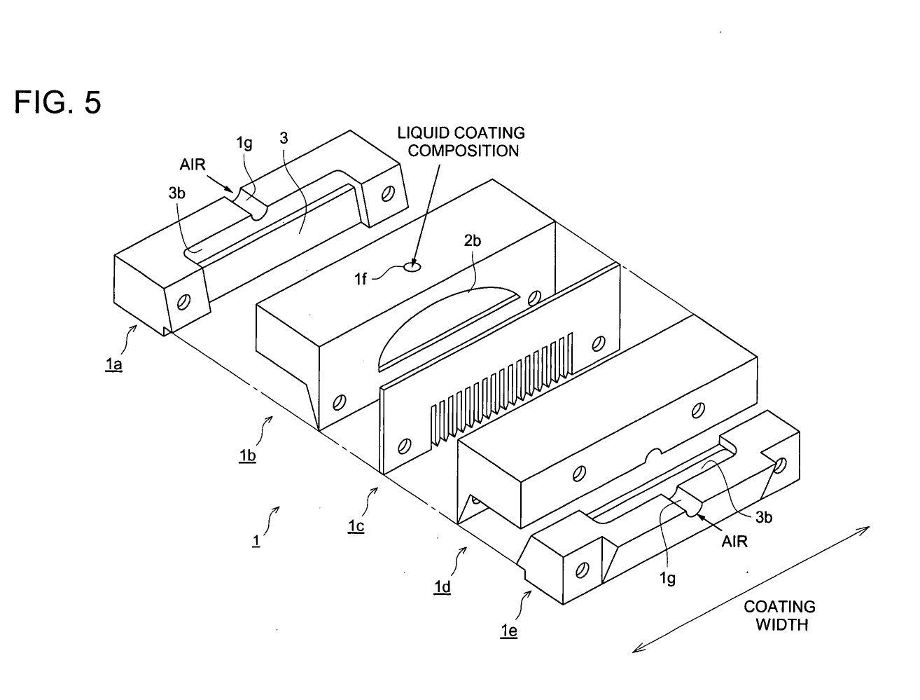

FIG. 5 is a perspective exploded view of spray coating device 1. In FIG. 5, reference codes 1b and 1d are die blocks which form a coating slit of the specified length, and allow the coating solution to flow down the aforesaid slit. Die block 1b receives the coating solution supplied from a coating solution supply source (not shown) and includes a coating solution supply opening 1f which allows the coating solution to pass into coating solution pocket 2b. The coating solution, which is retained in coating solution pocket 2b, flows down the coating solution slit formed between die blocks 1b and 1d. Symbol 1c is a shim (packing metal) interposed between block 1b and 1d which divides the slit for the coating solution formed between die blocks 1b and 1d in the perpendicular direction so as to form a plurality of coating solution nozzles across the coating width. According to the shape of the shim, the slit for the coating solution may be changed into either circular or rectangular openings. In the case of use of a slit extending across the coating width, the shim (packing metal) represented on 1c is not employed.

Further, 1a and 1e each is a gas block and forms a gas nozzle via the gap with die blocks 1b and 1d respectively, through which compressed gas passes. In such a case, the gas nozzle is a slit which extends across the coating width. Compressed air is supplied from an air source (not shown) to air supply channel 1g of each gas block, and after a temporary stay in gas pocket 3b, flows downward through the gas nozzles formed in the gap between die blocks 1b and 1d and gas blocks 1a and 1e respectively.

The coating solution, which flows down the channel forming the coating solution nozzle, and compressed air which flows down the two separate gas nozzles, collide just below the coating solution discharge section 2a, which is the bottom section of spray coating device 1, whereby liquid droplets are formed and are deposited onto the substrate S which is to be coated.

The angle of gas nozzles 3 with respect to coating solution nozzle 2 is preferably in the range of 5 to 50 degrees. Further, it is possible to appropriately select the distance between coating solution discharge section 2a of spray coating device 1 and substrate S to be in the range of about 2 to about 50 mm.

The supply rate of the coating solution from the coating solution nozzle varies, since it depends on the desired coating layer thickness, the concentration of coating solution, the coating speed, and the like. However, the coating amount on the substrate is preferably in the range of about 1 to about 50 g/m². When the coating amount is less than 1 g/m², it is difficult to form a uniformly stable coating layer, while when it exceeds 50 g/m², it becomes difficult to exhibit the desired effects of the present invention due to adverse effects as to a drying load. It is characteristic that the wet layer thickness of the coating solution is from 1 to 50 μm, and is preferably from 5 to 30 μm.

On the other hand, gases to be ejected from gas nozzles 3 are not particularly limited as long as they are suitable for coating, and commonly air is employed. Gas supply conditions are preferably in the range of about 1 to about 50 CMM/m (flow rate per coating width). In such cases, from the viewpoint of achieving uniform coating, inner pressure in the gas nozzles 3 is preferably at least 10 kPa.

The viscosity of coating solutions is preferably from 0.1 to 250 mPa·s, is preferably from 0.1 to 50 mPa·s, and is more preferably from 0.1 to 20 mPa·s. By supplying such low viscous coating solutions to spray coating device 1, it is possible to achieve a spray of uniform liquid droplets across the coating width.

Further, in order to achieve a spray of uniform liquid droplets across the coating width, the surface tension of coating solutions is adjusted from 20 to 70 mN/m, preferably from 20 to 50 mN/m, and more preferably from 20 to 30 mN/m.

Still further, when liquid droplets are formed by allowing a gas flow to collide with the coating solution while employing spray coating devices 1, a uniform spray is easily achieved by employing gas having an inner gas pressure of at least 10 kPa, more preferably at least 20 kPa, and still more preferably at least 50 kPa.

When employing the aforesaid means, a coating solution is scattered in the form of discontinuous liquid droplets across the coating width, instead of forming threads, whereby it is possible to uniformly apply the coating solution onto substrate S, even though the amount of the coating solution is small. As a result, it is possible to make a uniform coating thickness. Further, despite the supply of discontinuous liquid droplets onto substrate S, the amount of coating solution can be decreased to result in a minimal drying load.

[Coating Production Line]

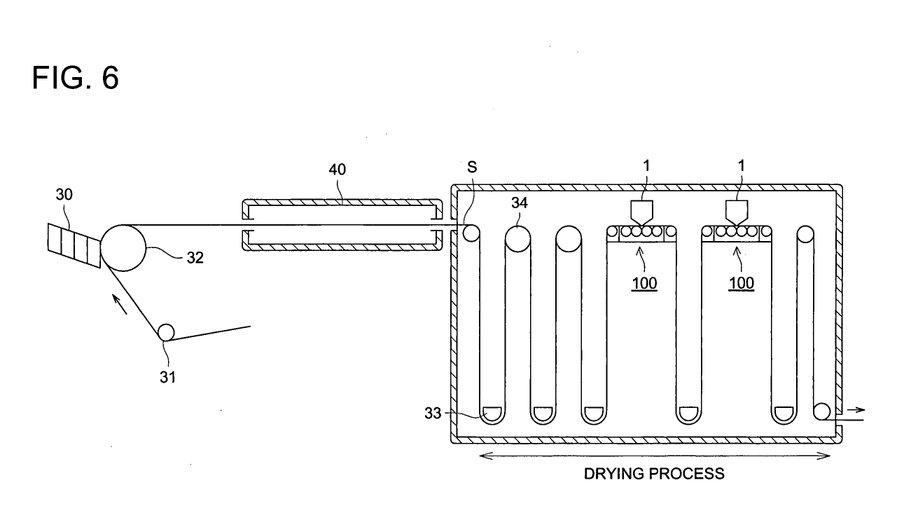

FIG. 6 is a schematic diagram showing one example of a coating production line provided with spray coating device 1 downstream of an ordinary slide bead type coating device 30 of the flow rate regulating type explained above. Here, substrate S is employed composed of a support coated with a composition layer. After coating the aforesaid composition layer, a plurality of spray coating devices 1 are arranged along the drying process. Herein, forming the composition layer, as well as coating the overcoating layer (being the uppermost layer) according to the present invention in a single production line, as stated above, is called “on-line coating”.

A support from a master roll is allowed to pass over conveyance roller 31, employing a conveyance means (not shown). Subsequently, during the process in which the support is reversed via the position of back-up roller 32, a coating solution forming a porous ink absorptive layer (a composition layer), which is supplied from a flow rate regulating type slide bead coating apparatus 30, is coated to form substrate S. Since the coating solution of the porous ink absorptive layer is composed of hydrophilic binders, the coated support is temporarily cooled and set in cooling zone 40.

Substrate S composed of the resulting support having thereon an ink absorptive layer, is conveyed to a drying zone. In the drying zone, there are alternately arranged reversers 33 which achieves reversing conveyance via blown air with no contact with the newly coated layer surface, and an ordinary conveyance roller 34 which performs reverse conveyance in contact with the back surface of substrate S, whereby substrate S is conveyed. In the aforesaid drying process, drying is carried out via blown warm air (the warm air blowing means is not shown). On the way of the aforesaid drying process, preferably after decreasing drying, another coating layer is deposited via liquid droplet spraying, as described above, employing two spray coating devices 1. It is preferable that at least one of two spray coating devices is arranged at or after the drying end point. Herein, two spray coating devices are employed, however, the number of apparatus may be only 1 or 3 or more. When coating, employing liquid droplet spray, is performed under a multistage system, drying load decreases, and also uniformity of the layer thickness is enhanced, and it becomes possible to apply a plurality of compositions which can not be mixed simultaneously.

When a thin layer is formed on substrate S, employing the coating method of the present invention, the coating speed may not be necessarily specified, since it varies depending on the types of coating solutions, the concentration, the solvent content, and the drying capacity. However, the coating speed is preferably from 50 to 300 m/min, but preferred is a coating speed of 100 to 300 m/min.

In the coating method of the present invention, when a layer is applied onto substrate S comprising a support having thereon at least one composition layer, the subsequent coating is preferably carried out at or after the decreasing drying of the composition layer formed on the support, and is more preferably carried out at or after end point of the drying process. Further, it is preferable that a coating process in which the aforesaid composition layer is coated, employing slide bead coating, and a coating process in which coating is carried out employing spray coating device 1 of the present invention are continuously performed employing a single production line (called on-line coating).

Due to the relatively small drying load, it is possible to apply the coating apparatus and the coating method of the present invention in the drying process of the aforesaid composition layer. Generally, in a drying process, drying is carried out by blowing drying air, conditioned to a specified temperature and humidity, onto the coated surface or the back of the support to prevent cracking of the layer, while continuously conveying a wet coated layer.

It becomes possible to achieve high speed thin layer coating of uniform layer thickness and resulting in reduced drying load by forming liquid droplets of a coating solution across the coating width in the direction which crosses the conveyance direction of substrate S and supplying the coating solution onto substrate S.

Herein, substrate S, as described in the present invention, refers to an object to be coated while employing the coating method of the present invention in which coating is carried out by spraying liquid droplets of a coating solution, and its structure is not particularly limited. The aforesaid long belt shaped substrates S, as well as those including the aforesaid substrate S having thereon a composition layer are preferred because it is possible to efficiently achieve the desired effects of the present invention. However, aforesaid substrates S are not limited to those above.

Further, in the present invention, substrate S is conveyed relative to coating solution discharge section 2a of spray coating device 1, whereby continuous coating production is performed. The coating solution discharge section 2a has a width which is equal to or greater than the coating width of substrate S (which refers to the length of the coating portion of substrate S perpendicular to the conveyance direction of the aforesaid substrate S), and is arranged so that substrate S passes under the falling coating solution which is then applied onto substrate S only by conveying substrate S relative to the coating apparatus. When substrate S is long belt-shaped, it is preferable that the aforesaid belt-shaped substrate S itself is allowed to be conveyed in the longitudinal direction thereof and the coating solution discharge section 2a is positioned across the width (the direction perpendicular to the longitudinal direction) of aforesaid substrate S. By conveying substrate S in one direction relative to spray coating device 1 and spraying the coating solution across the coating width in the form of liquid droplets, it is possible to coat a very thin layer having a uniform layer thickness, resulting in minimized drying load.

Further, across the coating width, liquid droplets, which are sprayed from the coating solution discharge section 2a of the spray coating device 1, are required to satisfy the following conditions:

1. The liquid droplet diameter is uniform;

2. The length of spray is uniform in the conveyance direction of the area on which liquid droplets fall;

3. The spray angle onto substrate S is uniform; and

4. The deposition speed of the droplets falling onto substrate S is uniform.

The uniform droplet diameter across the coating width, as described herein, specifically refers to variation of the average liquid droplet diameter of less than or equal to ±20 percent and preferably is less than or equal to ±10 percent.

It is possible to calculate the variation of the average liquid droplet diameter, employing a laser diffraction type particle size distribution measurement apparatus (RTS51114 (a registered trademark) of Malvern Instrument, Ltd. for example). The measurement method, described below, is specifically used.

First, a coating solution is sprayed employing spray coating device 1 which sprays the aforesaid coating solution in the form of liquid droplets, and the state of the spray is allowed to stabilize. Immediately after initiating spraying, the spray state is not stabilized due to variation of the discharge volume of the coating solution as well as variation of gas pressure. However, it is possible to achieve stabile while continuous spraying after a specified time.

[Coating Apparatus]

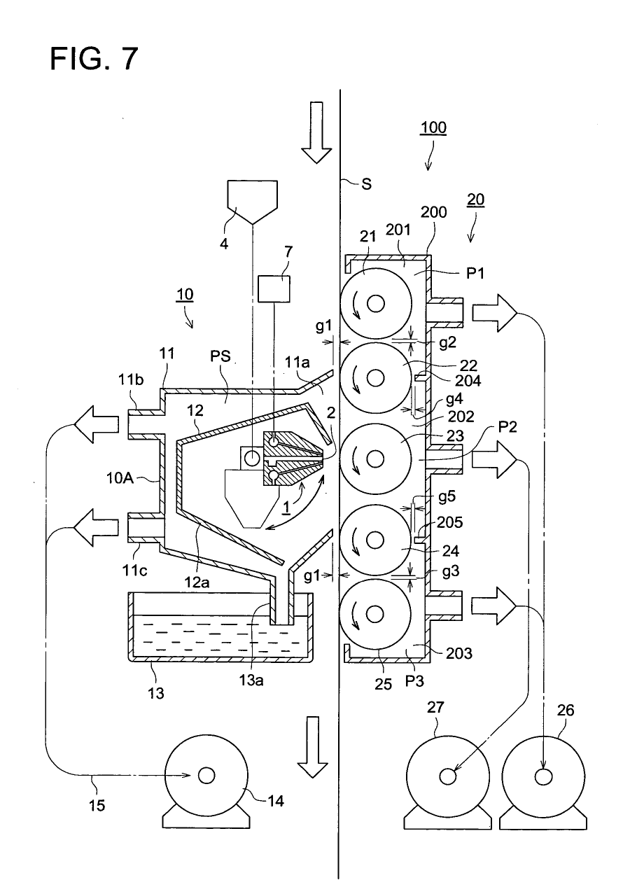

FIG. 7 is a cross-sectional view showing coating apparatus 100 coating a substrate to produce ink jet recording paper sheets.

Coating apparatus 100 is composed of coating means 10 including spray coating device 1 and conveying means 20 to convey substrate S.

[Coating Means 10]

Coating means 10 is composed of first casing 10A including spray coating device 1 and its outer casing 11 and inner casing 12, and of waste liquid collecting means 13 and pressure reducing means 14. Aperture area 11a located on the right side of outer casing 11 in FIG. 7 forms gap g1 facing a conveying passage of substrate S. Aperture areas 11b and 11c located on the left side of outer casing 11, are connected to pressure reducing means 14 via air suction ducts 15.

By activation of pressure reducing means 14, the interior pressure of outer casing 11 is maintained at a decompression Ps value of −50 through −3,000 Pa. The preferable range is −100 to −2,000 Pa, and more preferably −100 to −1,000 Pa.

Spray coating device 1 is located in inner casing 12 supported in outer casing 11. Inner casing 12 has a shielding wall on which a mist of the coating solution is scattered, which is ejected from coating nozzle 2 of spray coating device 1. This coating solution spattered on the shielding wall slides down on slope 12a and passes through liquid waste pipe 13a to be collected by liquid waste collecting means 13.

[Conveying Means 20]

Conveying means 20 is located behind substrate S which faces aperture area 11a of coating means 10. Conveying means 20 is composed of the second casing 200 forming plural decompression chambers 201, 202 and 203 separated from each other, and plural rollers including first feed rollers 21 and 22 located rotatably in decompression chamber (first decompression chamber) 201 at the entrance for substrate S, second feed rollers 24 and 25 located rotatably in decompression chamber (third decompression chamber) 203 at the exit of substrate S and back-up roller 23 located rotatably in decompression chamber (second decompression chamber) 202 facing coating solution nozzle 2 of spray coating device 1.

Respective reduced pressure values P1 and P3 of decompression chambers 201 and 203, which are connected to pressure reducing means 26, are maintained at −50 to −3,000 Pa, when substrate S is conveyed. Reduced pressure value P2 of decompression chamber 202, which is connected to pressure reducing means 27, is maintained at −50 to −3,000 Pa, when substrate S is conveyed. The preferable range of pressure values P1, P2 and P3 are −100 to −2,000 Pa, and more preferably, are −100 to −1,000 Pa. P1, P2 and P3 are set in this range and it is preferable to maintain the relationship of P1, P2, P3 and Ps, as P1<Ps<P2, and P3<Ps<P2, and it is preferable that, 0<P2−Ps<1,000 Pa, 0<Ps−P1<1,000 Pa, 0<Ps−P3<1,000 Pa, and more preferable that, 0<P2−Ps<500 Pa, 0<Ps−P1<500 Pa, 0<Ps−P3<500 Pa.

It is preferable that gap g1 between substrate S being in contact with circumferential surface of first feed roller 22 and the tip of aperture area 11a of outer casing 11 is maintained at 1 to 10 mm and more preferably 1 to 5 mm. Gap g2 between the circumferential surface of first feed rollers 21 and 22, and gap g3 between circumference surface of second feed rollers 24 and 25 are maintained at 0.1 to 2 mm.

Gap g4 between partition 204 separating decompression chambers 201 and 202, and circumferential surface of first feed roller 22, and gap g5 between partition 205 separating decompression chambers 202 and 203, and circumferential surface of second feed roller 25 are also maintained at 0.1 to 2 mm.

In decompression chamber 201 at the entrance of sheet conveyance, because substrate S is conveyed by rotating second rollers 21 and 22 while being aspirated by the reduced pressure, substrate S can be conveyed to the spray coating section in a flat and stable condition.

In the spray coating section where aperture area 11a of outer casing 11 and decompression chamber 202 face each other, substrate S is conveyed by rotating backup roller 23 and is maintained to be stable and flat by means of pressure reduction in outer casing 11 and in decompression chamber 202.

In decompression chamber 203, because substrate S is conveyed by rotating second feed rollers 24 and 25 under reduced pressure, substrate S after spray coating can be conveyed in a stable and flat condition.

[Masking Plate]

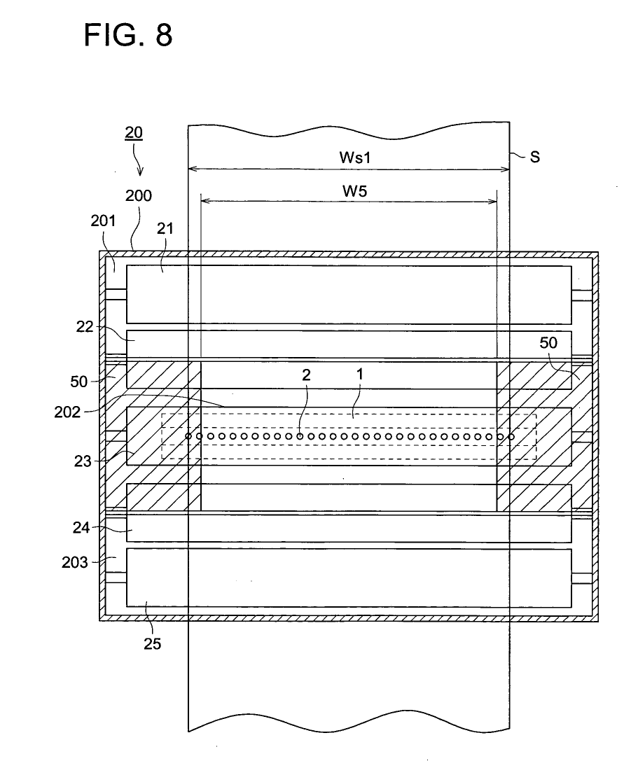

FIG. 8 is a frontal view of conveying means 20.

Masking plates 50 are located on both sides in the width direction of substrate S (hatched parts in FIG. 8). Masking plates 50 are located in the vicinity of coating solution discharge section 2a of spray coating device 1, and shield outer edges to form non-forming portions of coating solution layer (refer to FIGS. 1 and 8). It is preferred that masking plates can change gap g6 and the angle relative to substrate S. Gap g6 is preferably 1 to 15 mm, and more preferably 1 to 10 mm, and still more preferably 1 to 5 mm. Though the masking plates can be made of various materials, water repellant Teflon (R) material or Teflon (R) coating material is preferred. Auxiliary aspirating nozzles 70 are installed near masking plates 50 to aspirate surplus droplets. The dotted line shown in FIG. 8 represents the locating position of spray coating device 1 facing backup roller 23 of conveying means 20.

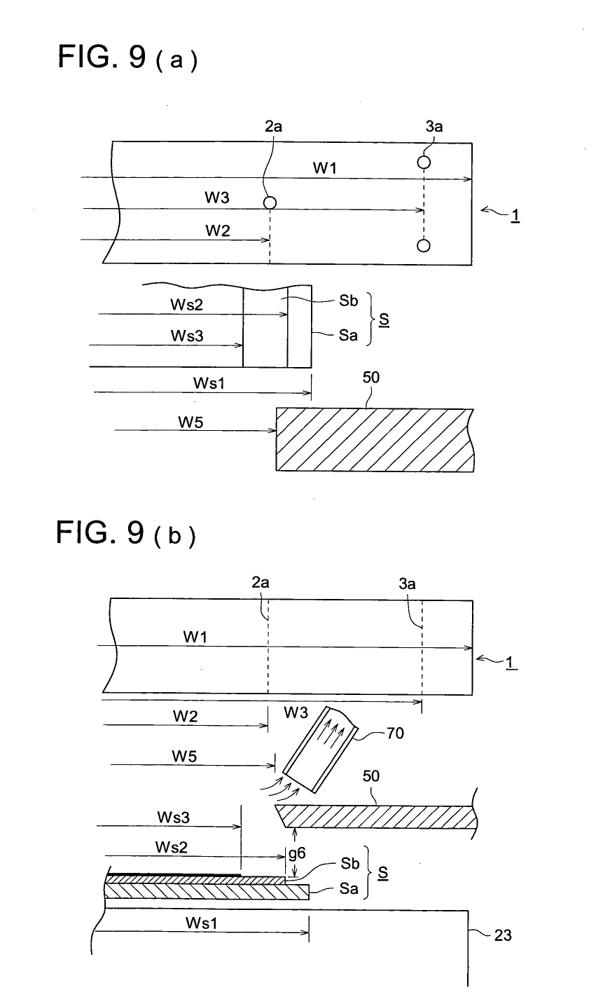

FIG. 9(a) is a schematic plan view explaining the dimensions of the respective width of spray coating device 1, substrate S and masking plates 50. FIG. 9(b) is cross-section A-A of FIG. 1 and also shows the dimensions of the respective width of spray coating device 1, substrate S and masking plates 50.

The total width of spray coating device 1 is W1, the width of liquid coating discharge section 2a of liquid coating nozzle 2 is W2 and the width of discharge section of gas nozzle 3 is W3 (refer to FIG. 4).

Substrate S has total width Ws1 and the total width of ink absorption layer Sb is Ws2.

Distance W5 between masking plates 50 is arranged to be a little less than total width Ws2 of ink absorption layer Sb, and is arranged to be a little longer than width W2 of coating solution discharge section 2a (Ws2>W5>W2).

Droplet particles 9 which are discharged from coating solution discharge section 2a and are sprayed by gas nozzle 3 are scattered at an angle of θ, and are deposited onto substrate S to create a uniform coating layer, while preventing coating by masking plates 50 in the vicinity of both edges of substrate S, effectively forming coating width Ws3.

The range of conditions where the conveying condition of the substrate and the coating condition of the substrate are favorable were determined, regarding the coating apparatus and the coating method of this invention, by researching the relationship between the reduced pressure value in the first casing containing the spray coating device for spray-coating the substrate and the reduced pressure value in the second casing located opposite of the substrate.

Optimal conditions of the gap between the masking plates and the substrate, to provide uniform coating, was also researched.

Further, the size of a gap between the masking plates and the substrate, the angle of the masking plates relative to the substrate and appropriateness of the plate materials were researched.

Next, equalization of coating by measures to prevent droplet scattering will be explained.

Specifically, auxiliary gas flow is conducted on both the upper side and lower side of the spray coating device, and the auxiliary gas flow is lead to the vicinity of a coating position and auxiliary gas flow guide plates 81 are installed so that droplets of spray coating are not widely diffused but are lead to the coating position uniformly and the objective to obtain coating uniformity by use of auxiliary gas flow is achieved by optimizing gap L between auxiliary gas flow guide plates 81 and the substrate.

As a specific condition range, it is preferable that Ph1 is in the range of 100 Pa to 5,000 Pa, and more preferably 100 Pa to 1,000 Pa, and Ph2 is preferably in the range of 100 Pa to 50,000 Pa, and more preferably 1,000 Pa to 50,000 Pa, and still more preferably 5,000 Pa to 50,000 Pa. When the pressure of auxiliary air flow was low, preventive effects against scattering of droplets could not be sufficiently achieved, and spot type defects caused by droplets were observed on the condition when the pressure was below 100 Pa. On the other hand, when the pressure of auxiliary air flow was high, the auxiliary air flow disturbed sprayed droplets and non-uniformity was caused by the air turbulence. Because an accompanying air flow is caused by conveyance of the substrate, liquid droplets tend to be scattered on the downstream side of the substrate by that influence and pressure value Ph2 should preferably be as high as possible, but without causing spray turbulence. Excessively large pressure value Ph1 is not preferable, because the accompanying air flow brings the auxiliary air to flow into the coating section and causes spray turbulence, resulting in non-uniform coating.

Regarding auxiliary gas flow guide plates 81, their existence affects the auxiliary gas flow, and without auxiliary gas flow guide plates 81, diffusion of auxiliary gas flow occurs and prevention of droplets from scattering becomes insufficient.

It is preferable that current plates 85 are installed into auxiliary gas flow guide plates 81. A porous material is applied for current plates 85, such as sponge material which allows gas to permeate through the material. Compressed air is sent to supply port 82 via a small tube, and because it is diffused in auxiliary gas flow guide plates 81, current plates 85 has a large effect to equalize the air flow across the width direction perpendicular to the conveyance direction. Regarding current plates 85, without these, uneven pressure distribution and occurrence of droplets were observed on specific positions across the substrate width. However, after installation of current plates 85, uniform coating was obtained without droplet spotting.

In the coating apparatus and coating method of this invention, a means for optimal coating conditions was sought by pursuing measures to prevent droplet scattering.

These research results will be described in the following paragraph via Examples 1 through 5.

### EXAMPLE 1

By means of a coating apparatus with afore-stated spray coating device, coating was conducted while changing the reduced pressure value of each section in various way. The coating solution, the substrate, the coating speed and the wet layer thickness which were employed were arranged as follows.

Coating solution: liquid of 1 percentage by mass in which water-soluble dye shown in Chem. 1 is dissolved in water

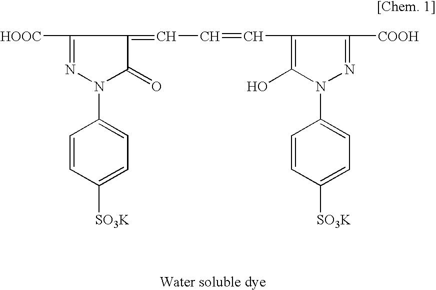

Substrate: Polyethylene laminated paper made in such a way that a support material is coated with an ink absorption layer and dried

Coating speed: 150 m/min

Wet layer thickness: 10 μm

Masking plate: employed

The result shown in Table 1 was obtained. The unit of pressure in the table is Pa.

TABLE 1

| P1 | P2 | P3 | Ps | Coating result | Transportability | |
|---|---|---|---|---|---|---|
| −30 | −30 | −30 | −30 | Uncoated droplets did not | Fluttering occurred at casing | |
| | | | | collect and a spot type | inlet/outlet and not transportable | |
| | | | | defects occurred (NG) | (NG) | |
| −500 | −300 | −500 | −30 | Uncoated droplets did not | Fluttering occurred in the coating | |
| | | | | collect and a spot type | section, transportable within the | |
| | | | | defects occurred (NG) | allowable range | |
| −500 | −300 | −500 | −400 | Good results without defects | No fluttering and good | T.I |
| | | | | | transportability | |
| −500 | −400 | −500 | −300 | Good results without defects | Fluttering occurred in the coating | T.I |
| | | | | | section, transportable within the | |
| | | | | | allowable range | |
| −300 | −400 | −300 | −500 | Good results without defects | Fluttering occurred in the coating | T.I |
| | | | | | section, transportable within the | |
| | | | | | allowable range | |
| −300 | −500 | −300 | −400 | Good results without defects | Fluttering occurred in the coating | T.I |
| | | | | | section, transportable within the | |
| | | | | | allowable range | |
| −1100 | −700 | −1100 | −900 | Good results without defects | No fluttering, resulting in good | T.I |
| | | | | | transportability | |
| −2900 | −2500 | −2900 | −2700 | Good results without defects | No fluttering, resulting in good | T.I |
| | | | | | transportability | |
| −5000 | −5000 | −5000 | −5000 | Dispersion of droplets | Substrate was sucked in and not | |
| | | | | resulted in non-uniformity of | transportable (NG) | |
| | | | | coating (NG) | | |
| −500 | −300 | −500 | −5000 | Dispersion of droplets | Fluttering occurred in the coating | |
| | | | | resulted in non-uniformity of | section, transportable within the | |
| | | | | coating (NG) | allowable range | |

Here, the unit is Pa.
T.I: This invention

### EXAMPLE 2

By means of the coating apparatus with afore-stated spray coating device, coating was conducted while changing gap between the first casing of the spray coating device and a substrate and also a gap between the masking plates and a substrate. The coating solution, the substrate, the coating speed and the wet-layer thickness which were employed were as follows. The masking plates were made of Teflon (R), however they can also be of other material coated with Teflon(R).

Coating solution: liquid of 1 percentage by mass in which water-soluble dye shown in Chem. 2 is dissolved in water

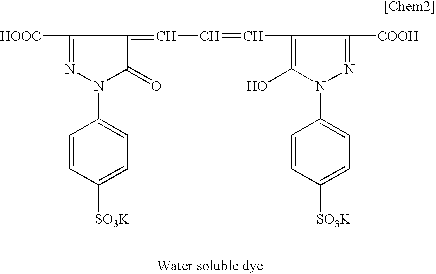

Substrate: Employed was polyethylene laminated paper made in such a way that a support material is coated with an ink absorption layer and dried.

Coating speed: 200 m/min

Wet layer thickness: 15 μm

Condition of reduced pressure: In the case of P1, P3=−500 Pa, P2=−300 Pa, and Ps=−400 Pa, the results shown in Table 2 were obtained.

Condition of reduced pressure: In the case of P1=P3=P2=Ps=−30 Pa, the results shown in Table 3 were obtained. The unit of pressure in Table 3 is Pa.

TABLE 2
In the case of P1 = −500 Pa, P2 = −300 Pa,
P3 = −500 Pa, P4 = −400 Pa (This invention)

| Gap between | | Gap | | |
|---|---|---|---|---|
| casing of | | between | | |
| spray coating | | masking | | |
| device and | | plate and | | |
| substrate | | substrate | | Results |
| 0.5 | mm | 0.5 | mm | Contact of substrate with casing and |
| | | | | masking plate caused non-stable |
| | | | | conveyance. Slight occurrence of dust |
| | | | | due to the contact caused new coating |
| | | | | defects, but within allowable range. |
| 0.5 | mm | 2 | mm | Contact between casing and substrate |
| | | | | caused non-stable conveyance. Slight |
| | | | | occurrence of dust due to the contact |
| | | | | caused new coating defects, but |
| | | | | within allowable range. |
| 2 | mm | 0.5 | mm | Contact between masking plate and |
| | | | | substrate caused non-stable |
| | | | | conveyance. Slight occurrence of dust |
| | | | | due to the contact caused new coating |
| | | | | defects, but within allowable range. |
| 1 | mm | 1 | mm | Stable conveyance and good coating |
| | | | | results |
| 2 | mm | 2 | mm | Stable conveyance and good coating |
| | | | | results |
| 10 | mm | 10 | mm | Stable conveyance and good coating |
| | | | | results |
| 10 | mm | 15 | mm | Stable conveyance and good coating |
| | | | | results |
| 12 | mm | 10 | mm | Reduced pressure value (PS) was non- |
| | | | | stable and diffusion of droplets |
| | | | | occurred causing scattered spot type |
| | | | | defects, but within allowable range. |
| 8 | mm | 17 | mm | Droplets flowed under masking plates |
| | | | | and spot type defects occurred, but |
| | | | | within allowable range on both sides. |
| 12 | mm | 17 | mm | Reduced pressure value (Ps) was |
| | | | | unstable and diffusion of droplets |
| | | | | occurred causing scattered spot type |
| | | | | defects across width of the |
| | | | | substrate, but within allowable |
| | | | | range. Liquid flowed around the edges |
| | | | | of both plates. |

TABLE 3
In the case of P1 = −30 Pa, P2 = −30
Pa, P3 = −30 Pa, P4 = −30 Pa

| | | |
|---|---|---|
| Gap between | | |
| casing of | | |
| spray | Gap between | |
| coating | masking | |
| device and | plate and | |
| substrate | substrate | Results |

| | | | | |
|---|---|---|---|---|
| 0.5 | mm | 0.5 | mm | Spot type defects occurred without |
| | | | | collection of uncoated droplets |
| | | | | (NG). Contact of substrate with |
| | | | | casing and masking plates made |
| | | | | stable conveyance impossible. |
| 2 | mm | 2 | mm | Spot type defects occurred without |
| | | | | collection of uncoated droplets |
| | | | | (NG). |
| 10 | mm | 10 | mm | Spot type defects occurred without |
| | | | | collection of uncoated droplets |
| | | | | (NG). |
| 12 | mm | 17 | mm | Spot type defects occurred without |
| | | | | collection of uncoated droplets |
| | | | | (NG). Reduced pressure value (Ps) |
| | | | | was unstable causing diffusion of |
| | | | | droplets. Liquid flowed around the |
| | | | | edges of both plates. |

### EXAMPLE 3

By means of a coating apparatus with afore-stated spray coating device, coating-was conducted in order to confirm effectiveness of the masking plate, the change of the plate materials, the change of the angle of the plates and auxiliary aspiration nozzles. The coating solution, the substrate, the coating speed and the wet layer thickness which were employed were arranged as follows.

Coating solution: The same coating solution as used in examples 1 and 2

Substrate: Polyethylene laminated paper made in such a way that a support material is coated with an ink absorption layer and dried

Coating speed: 250 m/min

Wet layer thickness: 15 μm

Condition of reduced pressure: In the case of P1, P3=−500 Pa, P2=−300 Pa and Ps=−400 Pa, the results shown in Table 2 were obtained.

When the masking plates were removed, a thick layer was produced on both outer edges, however there were almost no portions which were not dried due to the thick layer.

Applying only masking plates made of JIS (Japanese Industrial Standard) SUS304, parallel to the conveying direction of a substrate at both outer edges of the substrate allowed occasional spot type defects, but within the allowable range, by dripping of collected liquid from the masking plates.

However, by employing auxiliary aspiration nozzle 70 (illustrated in FIG. 9(b)), surplus liquid was aspirated and spot type defects did not occur.

By employing water repellant material such as Teflon (R) or a coating of Teflon (R) as water repellant treatment for the masking plates, liquid did not collect on the masking plates and no spot type defects occurred.

Further, by giving a decline to each masking plates from the center portion toward the outer edges (approx. 10° degree relative to substrate S), liquid did not collect on the masking plates and no spot type defects occurred.

### EXAMPLE 4

By means of a coating apparatus with afore-stated spray coating device, coating was conducted while changing discharge pressure value (Ph) in various ways including no pressure conditions. The coating solution, the substrate, the coating speed, the wet layer thickness which were employed then were arranged as follows.

Coating solution: liquid of 1 percentage by mass in which water-soluble dye shown in Chem. 4 is dissolved in water

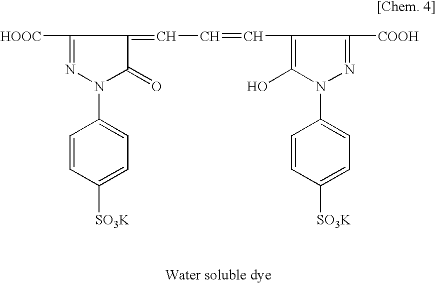

Substrate: polyethyene laminated paper made of a support material coated with an ink absorption layer and then dried.

Coating speed: 200 m/min

Wet layer thickness: 15 μm

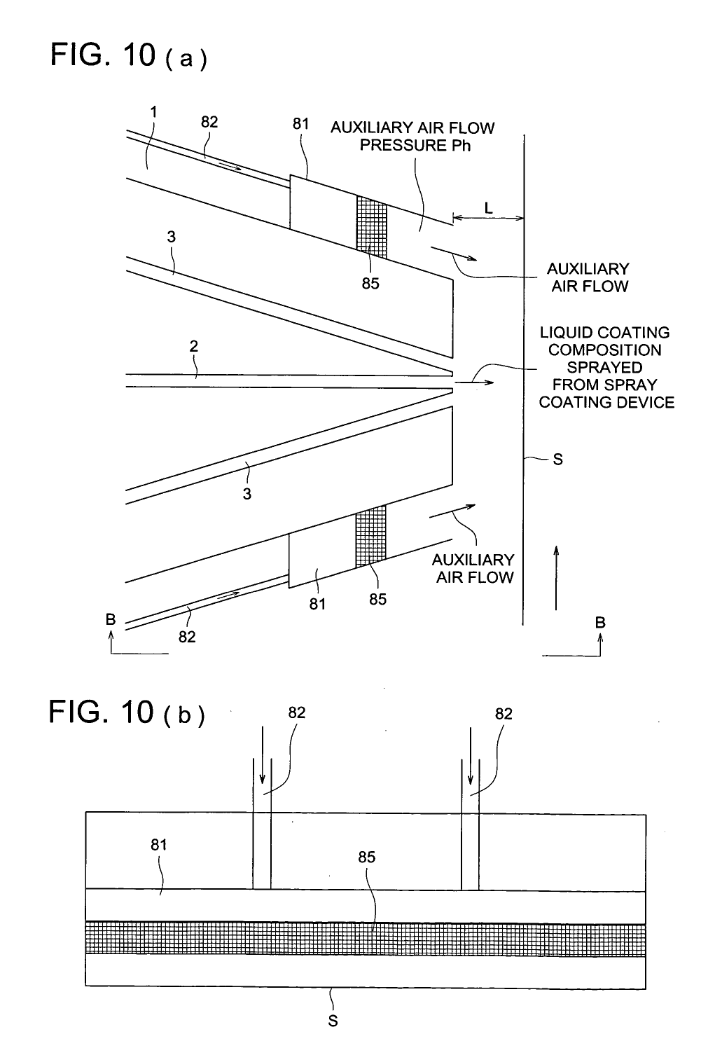

The result shown in Table 4 was obtained by employing auxiliary gas flow guide plate 81 and current plates 85 illustrated in FIG. 10. The unit of pressure in the table is Pa.

TABLE 4

| Ph1 | | Ph2 | | Coating result | |
|---|---|---|---|---|---|
| 0 | Pa | 0 | Pa | Scattering of droplets and spot | |
| | | | | type defects occurred. (Almost | |
| | | | | the whole surface, inapplicable) | |
| 150 | Pa | 0 | Pa | Scattering of droplets and spot | |
| | | | | type defects occurred. (Almost | |
| | | | | the whole surface, inapplicable) | |
| 0 | Pa | 150 | Pa | Scattering of droplets and spot | |
| | | | | type defects occurred. (Almost | |
| | | | | the whole surface) Much better | |
| | | | | than condition of Ph2 = 0 Pa, but | |
| | | | | inapplicable. | |
| 200 | Pa | 200 | Pa | Good coating results without spot | This |
| | | | | type defects | invention |
| 1,000 | Pa | 1,000 | Pa | Good coating results without spot | This |
| | | | | type defects | invention |
| 3,000 | Pa | 3,000 | Pa | Good coating results without spot | This |
| | | | | type defects | invention |
| 4,000 | Pa | 5,000 | Pa | Good coating results without spot | This |
| | | | | type defects | invention |
| 6,000 | Pa | 5,000 | Pa | Turbulence in sprayed liquid flow | |
| | | | | caused non-uniform coating | |
| | | | | (Inapplicable). | |
| 8,000 | Pa | 5,000 | Pa | Turbulence in sprayed liquid flow | |
| | | | | caused non-uniform coating | |
| | | | | (Inapplicable). | |
| 3,000 | Pa | 10,000 | Pa | Good coating results without spot | This |
| | | | | type defects | invention |
| 3,000 | Pa | 40,000 | Pa | Good coating results without spot | This |
| | | | | type defects, but slight | invention |
| | | | | turbulence in sprayed liquid flow | |
| | | | | caused slight non-uniform coating | |
| | | | | (Acceptable range). | |
| 3,000 | Pa | 60,000 | Pa | Turbulence in sprayed liquid flow | |
| | | | | caused excessive non-uniform | |
| | | | | coating (Inapplicable). | |
| 3,000 | Pa | 80,000 | Pa | Turbulence in sprayed liquid flow | |
| | | | | caused excessive non-uniform | |
| | | | | coating (Inapplicable). | |
| 7,000 | Pa | 80,000 | Pa | Turbulence in sprayed liquid flow | |
| | | | | caused excessive non-uniform | |
| | | | | coating (Inapplicable). | |

EXAMLE 5

By means of a coating apparatus 100 with afore-stated spray coating device 1, coating was conducted while changing the application condition of auxiliary gas flow guide plates 81 and current plates 85, and coating was conducted at a discharge pressure of Ph1=3,000 Pa/30,000 Pa and Ph2=6,000 Pa/60,000 Pa. The coating solution, the substrate, the coating speed, the wet layer thickness employed were arranged as follows.

Coating solution: The same coating solution as used in Examples 1 to 4

Substrate: Polyethylene laminated paper made in such a way that a support material is coated with an ink absorption layer and dried.

Coating speed: 250 m/min

Wet layer thickness: 20 μm

Auxiliary air flow pressure: 5,000 Pa

The result shown in Table 5 was obtained by employing auxiliary gas flow guide plates 81 and current plates 85 illustrated in FIG. 10. The unit of pressure in the table is Pa.

TABLE 5

| | | Auxiliary | | | |
|---|---|---|---|---|---|
| | | gas flow | Cur- | | |
| | | guide | rent | | |
| Ph1 | Ph2 | plate | plate | Coating result | |
| 3,000 | 6,000 | App. | App. | Good result without spot | T.I |
| | | | | type defects | |
| 3,000 | 6,000 | App. | Not | Spot type defects occurred | T.I |
| | | | | on specific positions across | |
| | | | | the width of the substrate | |
| | | | | (Allowable range). | |
| 3,000 | 6,000 | Not | App. | Slight droplet scattering | T.I |
| | | | | and slight spot type defects | |
| | | | | occurred across the width of | |
| | | | | the substrate (Allowable | |
| | | | | range). | |
| 3,000 | 6,000 | Not | Not | Slight droplet scattering | T.I |
| | | | | and slight spot type defects | |
| | | | | occurred across the width of | |
| | | | | the substrate (Many in | |
| | | | | specific positions. The | |
| | | | | lowest allowable range). | |
| 30,000 | 60,000 | App. | App. | Flow turbulence of spray | |
| | | | | liquid and non-uniform | |
| | | | | coating | |
| | | | | occurred (Inapplicable). | |
| 30,000 | 60,000 | App. | Not | Flow turbulence of spray | |
| | | | | liquid and non-uniform | |
| | | | | coating | |
| | | | | occurred (Inapplicable). | |
| 30,000 | 60,000 | Not | App. | Flow turbulence of spray | |
| | | | | liquid caused non- | |
| | | | | uniformity, and droplet | |
| | | | | scattering and spot type | |
| | | | | defects occurred on the | |
| | | | | whole surface | |
| | | | | (Inapplicable). | |
| 30,000 | 60,000 | Not | Not | Flow turbulence of spray | |
| | | | | liquid caused non- | |
| | | | | uniformity, and droplet | |
| | | | | scattering and spot type | |
| | | | | defects occurred on the | |
| | | | | whole surface (Heavy | |
| | | | | occurrence only on specific | |
| | | | | positions. Inapplicable). | |

Here, App.: Applied
Not: Not Applied
T.I: This invention

1. A coating apparatus for producing ink jet recording media comprising,
a conveying device to convey a substrate in a conveyance direction,
a spray coating device to spray liquid droplets of a coating solution across a coating width of the substrate perpendicular to the conveyance direction of the substrate to form a layer of the coating solution on the substrate,
a first casing in which the spray coating device is equipped and
a pressure reducing device to maintain a reduced pressure condition in the first casing,
wherein the coating apparatus conducts coating while maintaining reduced pressure value Ps of −50 to −3,000 Pa in the first casing.

2. The coating apparatus described in claim 1, further comprising,
masking plates so as to mask outer edges of the substrate, located in a vicinity of a coating solution discharge section of the spray coating device,
wherein size of each gap between the masking plates and the substrate is 1 to 15 mm at both outer edges of the substrate.

3. The coating apparatus described in claims 1, further comprising,
a second casing in which the conveying device is equipped opposite the substrate relative to the first casing and
a pressure reducing device to maintain a reduced pressure condition in the second casing,
wherein the reduced pressure value in the second casing is −50 to −3,000 Pa.

4. The coating apparatus described in claim 3,
wherein the second casing is separated into a plurality of decompression chambers and the pressure reducing device can individually set the reduced pressure value of each decompression chamber, and when the reduced pressure value in the decompression chamber at an entrance of the substrate on an upstream side in the conveyance direction of the substrate is represented by P1, the reduced pressure value in a middle decompression chamber facing the spray coating device is represented by P2, and the reduced pressure value in the decompression chamber at an exit of the substrate on a downstream side is represented by P3, the pressure is reduced so that relationships of P1<Ps<P2 and P3<Ps<P2 are maintained.

5. The coating apparatus described in claim 1,
wherein when an auxiliary gas flow is discharged toward a coating section along at least one of outermost surfaces of the spray coating device which has the outermost surfaces on a upstream side and a downstream side in the conveyance direction of the substrate, and when the discharge pressure on the upstream side in the conveyance direction of the substrate is represented by Ph1 and the discharge pressure on the downstream side in the conveyance direction of the substrate is represented by Ph2 , the condition of the discharge pressure is maintained so as to satisfy the relationships of 100 Pa<Ph1<5,000 Pa and 100 Pa<Ph2<50,000 Pa.

6. The coating apparatus described in claim 5, comprising,
a guide plate located on an outer portion of each outermost surface of the spray coating device where the auxiliary gas flows, to make the gas flow along the outermost surface of the spray coating device toward the coating section without diffusion of the gas.

7. The coating apparatus described in claim 6, further comprising,
current plates so as to make the auxiliary gas flowing along the outermost surfaces of the spray coating device toward the coating section flow uniformly across a whole width of the auxiliary gas flow.

8. The coating apparatus described in claim 1,
wherein size of a gap between the first casing and the substrate at the entrance and the exit of the substrate is 1 through 10 mm.

9. The coating apparatus described in claim 2, further comprising,
auxiliary aspiration nozzles arranged in a vicinity of the masking plates to aspirate surplus sprayed liquid droplets.

10. The coating apparatus described in claim 2,
wherein the masking plates are structured of a water repellant material.

11. The coating apparatus described in claim 2,
wherein each of the masking plates has a decline from the center of the substrate toward the outer edges of the substrate.

12. The coating apparatus described in claim 1, comprising,
at least one coating solution nozzle discharging the coating solution across the whole coating width and
a plurality of gas nozzles discharging a gas, close to an exit of the coating solution nozzle, so as to form liquid droplets by interaction of the gas flow with the coating solution discharged from the coating solution nozzle.

13. A coating method,
wherein ink jet recording media are produced by employing the coating apparatus described in claim l so as to spray liquid droplets of a coating solution by a spray coating device to form a layer of the coating solution on a substrate.
